(19) United States
(12) Patent Application Publication
(10) Pub. No.: US 2011/0084955 A1
(43) Pub. Date: Apr. 14, 2011

(54) ORGANIC LIGHT EMITTING DISPLAY

(76) Inventor: Yang-Wan Kim, Yongin-city (KR)

(21) Appl. No.: 12/838,409

(22) Filed: Jul. 16, 2010

(30) Foreign Application Priority Data
Oct. 12, 2009 (KR) 10-2009-0096760

(51) Int. Cl. G06F 3/038

(52) U.S. Cl. 345/212; 345/82

(57) ABSTRACT

An organic light emitting display is capable of displaying an image with desired brightness regardless of the deterioration of organic light emitting diodes (OLED) and the voltage reduction of a first power source. The organic light emitting display includes pixels positioned at crossing regions of scan lines, emission control lines, sensing lines, and data lines, a sensor for extracting information from the pixels on deterioration of organic light emitting diodes (OLEDs) and information on threshold voltages and mobilities of transistors of the pixels, a converter for changing supplied data to generate corrected data using the information on the deterioration of the OLEDs and the information on the threshold voltages and mobilities of the driving transistors, and a data driver for generating data signals to be supplied to the data lines using the corrected data.

### CROSS-REFERENCE TO RELATED APPLICATION

This application claims priority to and the benefit of Korean Patent Application No. 10-2009-0096760, filed on Oct. 12, 2009, in the Korean Intellectual Property Office, the entire content of which is incorporated herein by reference.

### BACKGROUND

1. Field

An embodiment of the present invention relates to an organic light emitting display.

2. Description of the Related Art

Recently, various flat panel displays (FPDs) having reduced weight and volume in comparison to cathode ray tubes (CRTs) have been developed. The FPDs include liquid crystal displays (LCDs), field emission displays (FEDs), plasma display panels (PDPs), and organic light emitting displays.

Among the FPDs, the organic light emitting displays display images using organic light emitting diodes (OLEDs) that generate light by the re-combination of electrons and holes. The organic light emitting display has a high response speed and is driven with low power consumption.

### SUMMARY

An aspect of the present invention relates to an organic light emitting display capable of displaying an image with desired brightness regardless of the deterioration of an organic light emitting diode (OLED) and the voltage reduction of a first power source.

In order to achieve the foregoing and/or other aspects of the present invention, there is provided an organic light emitting display, including pixels positioned at crossing regions of scan lines, emission control lines, sensing lines, and data lines, wherein each of the pixels includes an organic light emitting diode (OLED) having a cathode electrode coupled to a second power source, a second transistor having a second electrode coupled to an anode electrode of the OLED in order to supply a current to the OLED, a first transistor coupled between a data line of the data lines and a gate electrode of the second transistor and configured to be turned on when a scan signal is supplied to a scan line of the scan lines, a third transistor coupled between a first electrode of the second transistor and a first power source and configured to be turned off when an emission control signal is supplied to an emission control line of the emission control lines, and a storage capacitor coupled between the gate electrode of the second transistor and the first electrode of the second transistor. The organic light emitting display also includes a sensor for extracting information from the pixels on deterioration of OLEDs and information on threshold voltages and mobilities of the second transistors of the pixels, a converter for changing supplied data to generate corrected data using the information on the deterioration of the OLEDs and the information on the threshold voltages and mobilities of the second transistors, and a data driver for generating data signals to be supplied to the data lines using the corrected data.

The voltage of the data signals may be less than or equal to a threshold voltage of the OLED. The voltage of a first power supplied by the first power source may be higher than the threshold voltage of the OLED. A data signal of the data signals may be set to completely turn on the second transistor. The corrected data may compensate for the deterioration of the OLEDs and the threshold voltages and mobilities of the driving transistors of the pixels. The organic light emitting display may further include a switching unit coupled to the data lines for selectively coupling the data lines to one of the sensor or the data driver.

The switching unit may include a first switch coupled between the data lines and the data driver and configured to be turned on in a driving period where the data signals are supplied and a second switch coupled between the data lines and the sensor and configured to be turned on in a first sensing period where the information on the deterioration of the OLEDs is extracted and in a second sensing period where the information on the threshold voltages and mobilities of the driving transistors is extracted. The sensor may include a sensing circuit including a current source unit for supplying a first current to the OLED in the first sensing period and a current sink unit for sinking a second current via the second transistors of the pixels in the second sensing period and an analog-to-digital converter (ADC) for converting voltages corresponding to the first current and the second current into digital values. The converter may include a memory for storing the deterioration information converted into a digital value by the sensor and the information on the threshold voltages and mobilities of the second transistors and a converting circuit for generating the corrected data using the information stored in the memory.

Another embodiment of the invention provides a method of driving an organic light emitting display including extracting information on deterioration of an organic light emitting diode (OLED) and threshold voltage and mobility of a driving transistor via a data line, storing the extracted information, correcting input data received from an external source using the extracted information, and displaying an image in accordance with the corrected input data. Extracting information on the deterioration of the OLED via the data line may include connecting the data line to a sensor comprising a current source, turning on a sensing transistor coupled between the data line and an electrode of the OLED, applying, to the OLED, a current from the current source through the data line and through the sensing transistor, and measuring a first voltage corresponding to the current which appears at an anode electrode of the OLED. Measuring the first voltage may include converting the first voltage to a first digital value.

Extracting information on the threshold voltage and mobility of the driving transistor may include connecting the data line to a sensor comprising a current sink, turning on an emission control transistor coupled between a voltage source and a source or drain electrode of the driving transistor, turning on a sensing transistor coupled between the data line and an electrode of the driving transistor, diode connecting the driving transistor, applying a voltage across a source electrode and a drain electrode of the driving transistor, receiving, at the current sink, a current flowing through the emission control transistor, between the source electrode and drain electrode of the driving transistor and through the sensing transistor, and measuring a second voltage corresponding to the current which appears at a gate electrode of the driving transistor. Measuring the second voltage may include converting the second voltage to a second digital value.

Another embodiment of the present invention provides an organic light emitting display including pixels positioned at crossing regions of scan lines, emission control lines, sensing lines, and data lines, wherein each of the pixels includes an organic light emitting diode (OLED) having a cathode electrode coupled to a second power source, a second transistor having a first electrode coupled to a first power source and a second electrode coupled to an anode electrode of the OLED in order to supply a current to the OLED, a first transistor coupled between a data line of the data lines and a gate electrode of the second transistor and configured to be turned on when a scan signal is supplied to a scan line of the scan lines, and a fourth transistor coupled between the second electrode of the second transistor and the data line and configured to be turned on when a sensing signal is supplied to a sensing line of the sensing lines. The organic light emitting display also includes a sensor for extracting information on deterioration of OLEDs and information on threshold voltages and mobilities of the second transistors of the pixels, a converter for changing supplied data to generate corrected data using the information on the deterioration of the OLEDs and the information on the threshold voltages and mobilities of the second transistors, and a data driver for generating data signals to be supplied to the data lines using the corrected data.

The sensor may be configured to extract information on the deterioration of an OLED of a pixel of the pixels as a voltage appearing at the anode electrode of the OLED, the voltage corresponding to a current flowing from the sensor through the data line, the fourth transistor, and the OLED.

The sensor may also be configured to extract information on a second transistor of a pixel of the pixels as a voltage appearing at the gate electrode of the second transistor, the voltage corresponding to a current flowing from the first power source through the second transistor, the fourth transistor, and the data line to the sensor.

The organic light emitting display according to an embodiment of the present invention generates data signals so that the deterioration of the OLEDs included in the pixels and the threshold voltages and mobilities of the driving (or second) transistors included in the pixels may be compensated for and that an image with a desired brightness may be displayed. A pixel according to an embodiment of the present invention controls the amount of current supplied to the OLED regardless of the voltage reduction of the first power source so that an image with desired brightness may be displayed.

### BRIEF DESCRIPTION OF THE DRAWINGS

The accompanying drawings, together with the specification, illustrate exemplary embodiments of the present invention, and, together with the description, serve to explain the principles of aspects of the present invention.

FIG. 1 is a circuit diagram illustrating a conventional pixel;

FIG. 2 is a schematic view illustrating an organic light emitting display according to one embodiment of the present invention;

FIG. 3 is a view illustrating an embodiment of the pixel of FIG. 2;

FIG. 4 is a schematic view illustrating the switching unit, the sensor, and the converter of FIG. 2 in detail; and

FIGS. 5A, 5B, and 5C are waveform diagrams illustrating a method of driving the organic light emitting display according to one embodiment of the present invention.

### DETAILED DESCRIPTION

Hereinafter, certain exemplary embodiments according to the present invention will be described with reference to the accompanying drawings. Here, when a first element is described as being coupled to a second element, the first element may be directly coupled to the second element or may be indirectly coupled to the second element via a third element. Further, some of the elements that are not essential to a complete understanding of the invention are omitted for clarity. Also, like reference numerals refer to like elements throughout.

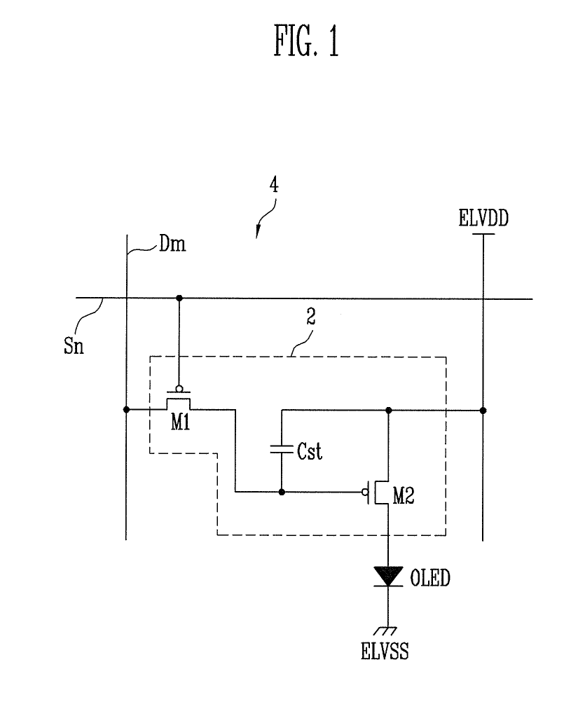

FIG. 1 is a circuit diagram illustrating a pixel of a conventional organic light emitting display.

Referring to FIG. 1, a pixel 4 of the conventional organic light emitting display includes an organic light emitting diode (OLED) and a pixel circuit 2 coupled to a data line Dm and a scan line Sn to control the OLED.

The anode electrode of the OLED is coupled to the pixel circuit 2 and the cathode electrode of the OLED is coupled to a second power source ELVSS. The OLED emits light with the brightness corresponding to the current supplied from the pixel circuit 2.

The pixel circuit 2 controls the amount of current supplied to the OLED to correspond to a data signal supplied to the data line Dm when a scan signal is supplied to the scan line Sn.

Therefore, the pixel circuit 2 includes a second transistor M2 coupled between a first power source ELVDD and the OLED, a first transistor M1 coupled to the second transistor M2, the data line Dm, and the scan line Sn, and a storage capacitor Cst coupled between the gate electrode and the first electrode of the second transistor M2.

The gate electrode of the first transistor M1 is coupled to the scan line Sn and the first electrode of the first transistor M1 is coupled to the data line Dm. The second electrode of the first transistor M1 is coupled to one terminal of the storage capacitor Cst.

Here, the first electrode is one of a source electrode and a drain electrode and the second electrode is an electrode different from the first electrode. For example, when the first electrode is the source electrode, the second electrode is the drain electrode. The first transistor M1 coupled to the scan line Sn and the data line Dm is turned on when the scan signal is supplied from the scan line Sn to supply the data signal supplied from the data line Dm to the storage capacitor Cst. The storage capacitor Cst stores the voltage corresponding to the data signal.

The gate electrode of the second transistor M2 is coupled to one end of the storage capacitor Cst and the first electrode of the second transistor M2 is coupled to the other terminal of the storage capacitor Cst and the first power source ELVDD. The second electrode of the second transistor M2 is coupled to the anode electrode of the OLED.

The second transistor M2 controls the amount of current that flows from the first power source ELVDD to the second power source ELVSS via the OLED in accordance with the voltage stored in the storage capacitor Cst. The OLED emits light corresponding to the amount of current supplied from the second transistor M2.

However, the conventional organic light emitting display may not display an image with desired brightness due to a change in efficiency due to the deterioration of the OLED over time. Therefore, for a given data signal, a deteriorated OLED may generate light with lower brightness than an OLED that has not deteriorated.

In addition, in the conventional organic light emitting display, the value of the voltage from the first power source ELVDD varies in accordance with the position of the pixel circuit 2 so that an image with desired brightness may not be displayed because of the voltage drop.

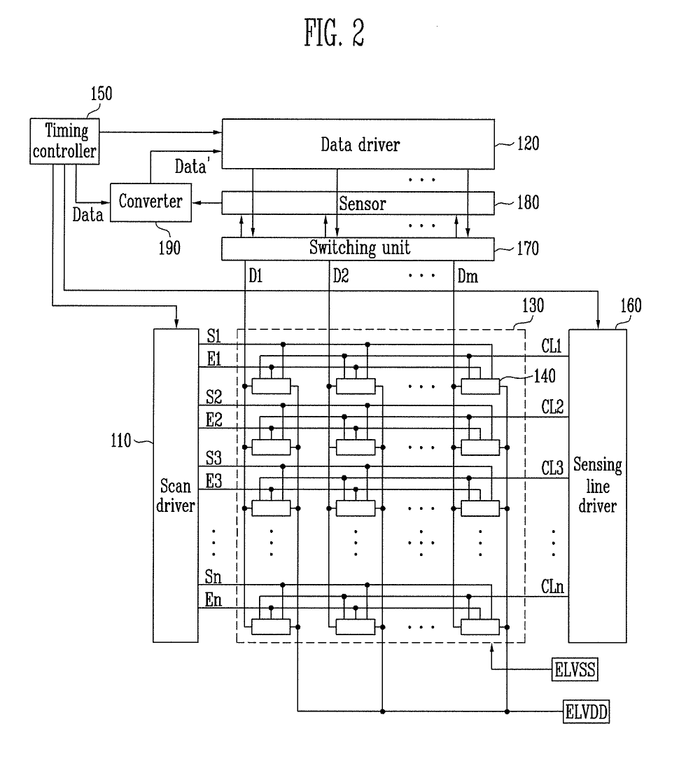

Hereinafter, exemplary embodiments of the present invention will be described in detail with reference to FIGS. 2 to 5C.

FIG. 2 is a view illustrating an organic light emitting display according to one embodiment of the present invention.

Referring to FIG. 2, the organic light emitting display according to one embodiment of the present invention includes a display unit 130 including pixels 140 coupled to scan lines S1 to Sn, emission control lines E1 to En, sensing lines CL1 to CLn, and data lines D1 to Dm, a scan driver 110 for driving the scan lines S1 to Sn and the emission control lines E1 to En, a sensing line driver 160 for driving the sensing lines CL1 to CLn, a data driver 120 for driving the data lines D1 to Dm, and a timing controller 150 for controlling the scan driver 110, the data driver 120, and the sensing line driver 160.

In addition, the organic light emitting display according to one embodiment of the present invention further includes a sensor 180 for extracting (e.g., sensing) information on the deterioration of organic light emitting diodes (OLED) included in the pixels 140 and information on the threshold voltage and mobility of a driving transistor, a switching unit 170 for selectively coupling the sensor 180 and a data driver 120 to data lines D1 to Dm, and a converter 190 for storing the information sensed by the sensor 180 and for converting input data so as to display an image with substantially uniform brightness regardless of the deterioration of the OLEDs and the threshold voltage and mobility of the driving transistor using the sensed information.

The scan driver 110 supplies scan signals to the scan lines S1 to Sn in accordance with the control of the timing controller 150. In addition, the scan driver 110 supplies emission control signals to the emission control lines E1 to En in accordance with the control of the timing controller 150.

The sensing line driver 160 supplies sensing signals to the sensing lines CL1 to CLn in accordance with the control of the timing controller 150.

The data driver 120 supplies the data signals to the data lines D1 to Dm in accordance with the control of the timing controller 150.

The display unit 130 includes pixels 140 positioned at the crossing regions of the scan lines S1 to Sn and the emission control lines E1 to En, with the data lines D1 to Dm. The pixels 140 receive a first power from a first power source ELVDD and a second power from a second power source ELVSS from the outside (e.g., an external source). The pixels 140 control the amount of current supplied from the first power source ELVDD to the second power source ELVSS via the OLEDs in accordance with the data signals. The pixels 140 control the amount of current that flows to the OLEDs regardless of the voltage reduction of the first power source ELVDD.

According to an embodiment of the present invention, the voltages of the data signals are set so that the driving transistors included in the pixels 140 are completely turned on. As an example, the voltage of the data signals is equal to or larger than the threshold voltage of the OLEDs included in the pixels 140. The first power source ELVDD has a higher voltage than the threshold voltage of the OLEDs. The voltages of the first power supplied by the first power source ELVDD, the data signal, and the threshold voltage of the OLED are set as illustrated in EQUATION 1.

ELVDD>Voled≧Vdata Equation 1

wherein, Vdata represents the voltage of the data signal and Voled represents the threshold voltage of the OLED. The voltage of the second power source ELVSS that is not included in EQUATION 1 is experimentally determined so that current may stably flow to the OLED. For example, the voltage of the second power source ELVSS may be set as a voltage higher than the voltage Vdata of the data signal.

The switching unit 170 selectively couples the sensor 180 or the data driver 120 to the data lines D1 to Dm. Therefore, the switching unit 170 includes a pair of switches coupled to each of the data lines D1 to Dm (that is, in each channel).

The sensor 180 extracts information on the deterioration of the OLEDs included in the pixels 140 and supplies the extracted deterioration information to the converter 190. In addition, the sensor 180 extracts information on the threshold voltage and mobility of the driving transistor, which is included in each of the pixels 140, and supplies the extracted information on the threshold voltage and mobility to the converter 190. Therefore, the sensor 180 includes a sensing circuit coupled to each of the data lines D1 to Dm (that is, coupled to each channel).

The information on the deterioration of the OLEDs may be extracted in a first non-display period after a power source is applied to the organic light emitting display before an image is displayed. That is, the information on the deterioration of the OLEDs may be extracted whenever the power source is applied to the organic light emitting display.

The information on the threshold voltage and mobility of the driving transistor may be extracted after the power source is applied to the organic light emitting display before the image is displayed and may be extracted before the organic light emitting display is initially distributed as a product (e.g., during the manufacturing process) so that the information on the threshold voltages and mobilities may be provided as previously set information when the product is distributed. That is, the information on the threshold voltages and mobilities of the driving transistors may be extracted whenever the power source is applied to the organic light emitting display or the extraction result is previously stored before distributing the product so that, whenever the power source is applied, the information on the threshold voltages and mobilities is not extracted but the previously stored information may be used. Hereinafter, for the sake of convenience, a period in which information on the threshold voltages and mobilities of the driving transistors is extracted is referred to as a second sensing period.

The converter 190 stores information on the deterioration of the OLEDs and information on the threshold voltages and mobilities of the driving transistors that are supplied from the sensor 180. The converter 190 stores the information on the deterioration of the OLEDs of the pixels and the information on the threshold voltages and mobilities of the driving transistors of the pixels. Therefore, the converter 190 includes a memory and a converting circuit for converting data Data from the timing controller into corrected data Data′ so that, using the information stored in the memory, an image with substantially uniform brightness may be displayed regardless of the deterioration of the OLEDs and the threshold voltages and mobilities of the driving transistors.

The timing controller 150 controls the data driver 120, the scan driver 110, and the sensing line driver 160. The timing controller 150 supplies data Data input from the outside (e.g., an external source) to the converter 190. The data Data output from the timing controller 150 is converted into the corrected data Data′ so that the converter 190 compensates for the deterioration of the OLEDs and the threshold voltages and mobilities of the driving transistors and supplies the corrected data Data′ to the data driver 120. Then, the data driver 120 generates the data signals using the converted corrected data Data′ and supplies the generated data signals to the pixels 140.

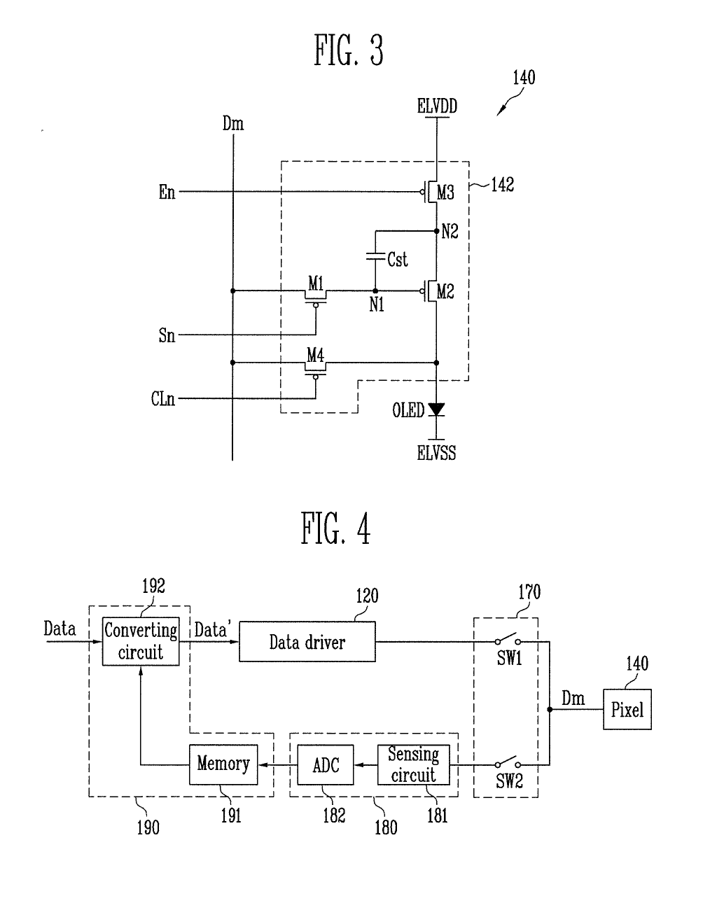

FIG. 3 is a circuit diagram illustrating one embodiment of the pixel of FIG. 2. For the sake of convenience, the pixel coupled to the mth data line Dm and the nth scan line Sn is illustrated.

Referring to FIG. 3, the pixel 140 according to one embodiment of the present invention includes an OLED and a pixel circuit 142 for supplying current to the OLED.

The anode electrode of the OLED is coupled to the pixel circuit 142 and the cathode electrode of the OLED is coupled to the second power source ELVSS. The OLED generates light with a brightness corresponding to the current supplied from the pixel circuit 142.

The pixel circuit 142 receives the data signal supplied to the data line Dm when a scan signal is supplied to the scan line Sn. In addition, the pixel circuit 142 provides the information on the deterioration of the OLED and/or the information on the threshold voltage and mobility of the driving transistor (that is, the second transistor M2) to the sensor 180 when a sensing signal is supplied to the sensing line CLn. Therefore, in one embodiment, the pixel circuit 142 includes four transistors M1 to M4 and a storage capacitor Cst.

A gate electrode of the first transistor M1 is coupled to the scan line Sn and a first electrode of the first transistor M1 is coupled to the data line Dm. A second electrode of the first transistor M1 is coupled to a first node N1 (that is, a gate electrode of the second transistor M2). The first transistor M1 is turned on when the scan signal is supplied to the scan line Sn. Here, the scan signal is supplied in a second sensing period where the information on the threshold voltage and mobility of the second transistor M2 is sensed and in a driving period where the data signal is stored in the storage capacitor Cst.

The gate electrode of the second transistor M2 is coupled to the first node N1 and a first electrode of the second transistor M2 is coupled to a second node N2 (that is, a second electrode of the third transistor M3). A second electrode of the second transistor M2 is coupled to an anode electrode of the OLED. The second transistor M2 supplies a current corresponding to the voltage stored in the storage capacitor Cst to the OLED.

A gate electrode of the third transistor M3 is coupled to the emission control line En and a first electrode of the third transistor M3 is coupled to the first power source ELVDD. The second electrode of the third transistor M3 is coupled to the second node N2. The third transistor M3 is turned off when an emission control signal is supplied to the emission control line En and is turned on when an emission control signal is not supplied to the emission control line. Here, the emission control signal is a logic high signal when it is supplied. The emission control signal is supplied in a period in which a data signal is supplied to the pixel 140 coupled to the emission control line En in a driving period and in the first sensing period in which the information on the deterioration of the OLED is extracted.

The fourth transistor M4 is coupled between the data line Dm and the anode electrode of the OLED. A gate electrode of the fourth transistor M4 is coupled to the sensing line CLn. The fourth transistor M4 is turned on when the sensing signal is supplied to the sensing line CLn and is turned off when the sensing signal is not supplied to the sensing line CLn. Here, the sensing signals are sequentially supplied to the sensing lines CL1 to CLn in the first sensing period and the second sensing period.

The storage capacitor Cst is coupled between the first node N1 and the second node N2. The storage capacitor Cst stores a voltage corresponding to the data signal and the first power source ELVDD.

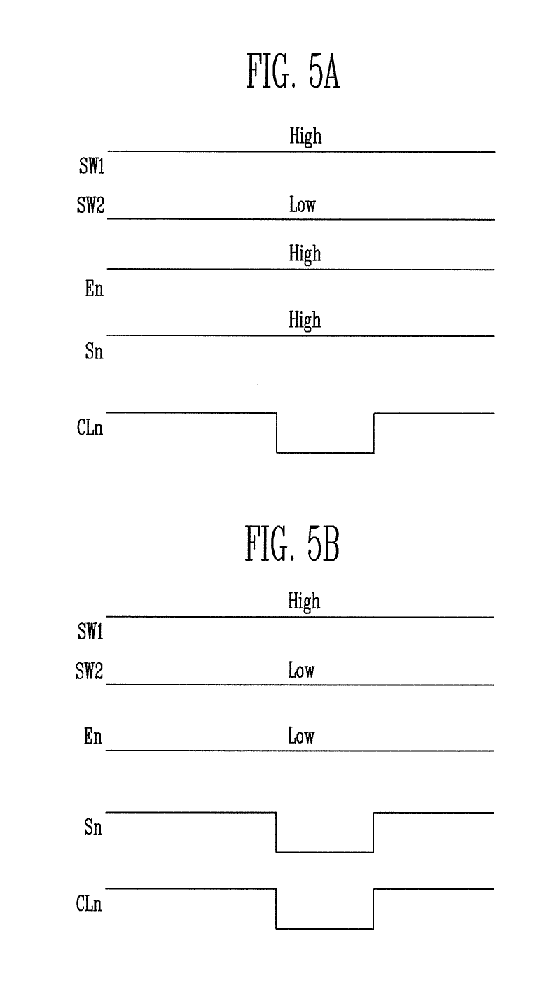

FIG. 4 is a view illustrating the switching unit, the sensor, and the converter of FIG. 2. In FIG. 4, for the sake of convenience, the pixel coupled to the mth data line Dm is illustrated.

Referring to FIG. 4, a pair of switches SW1 and SW2 are provided in each channel of the switching unit 170. A sensing circuit 181 and an analog-to-digital converter (hereinafter, referred to as ADC) 182 are provided in each channel of the sensor 180. In other embodiments, a plurality of channels may share one ADC or all of the channels may share one ADC. The converter 190 includes a memory 191 and a converting circuit 192.

The first switch SW1 of the switching unit 170 is positioned between the data driver 120 and the data line Dm. The first switch SW1 is turned on when the data signal is supplied through the data driver 120. That is, the first switch SW1 maintains a turned-on state in a period where a data signal is being provided.

The second switch SW2 of the switching unit 170 is positioned between the sensor 180 and the data line Dm. The second switch SW2 is turned on in the first sensing period and the second sensing period.

The sensing circuit 181 supplies current to the pixel 140 to sense the deterioration of the OLED (e.g., the information on the deterioration of the OLED) or sinks current from the pixel 140 to sense the mobility and threshold voltage of the driving transistor (e.g., the information on the mobility and threshold voltage of the driving transistor). Therefore, the sensing circuit 181 includes a current supply unit and a current sink unit. The current supply unit supplies a first current to the pixel 140 and the current sink unit sinks a second current from the pixel 140.

The first current supplied from the current supply unit is supplied to the OLED. A first voltage corresponding to the first current appears across the OLED and the information on the deterioration of the OLED can be determined from (or is included in) the first voltage. For example, a resistance value changes in accordance with the deterioration of the OLED. Therefore, the value of the first voltage changes to correspond to the deterioration of the OLED so that the information on the deterioration of the OLED may be extracted.

The value of the first current may vary so that a voltage (or a predetermined voltage) may be appear across the OLED within a time (or a predetermined time). For example, the first current may be set as current that flows to the OLED when the pixel 140 emits light with the maximum brightness.

In the second sensing period, the current sink unit in the sensing circuit 181 sinks the second current via the second transistor M2 included in the pixel 140. At this time, a second voltage corresponding to the second current appears at the gate electrode of the second transistor M2 and the information on the threshold voltage and mobility of the second transistor M2 can be determined from (or is included in) the second voltage. The second current is set so that the information on the threshold voltage and mobility of the second transistor M2 may be stably extracted. For example, the second current may have the same value as the first current.

The ADC 182 converts the first voltage into a first digital value and converts the second voltage into a second digital value to supply the first digital value and the second digital value to the converter 190.

The converter 190 includes a memory 191 and a converting circuit 192.

The memory 191 stores the first digital value and the second digital value that are supplied from the ADC 182. The memory 191 stores the information on the threshold voltage and mobility of the second transistor M2 of each of the pixels 140 included in the display unit 130 and the information on the deterioration of the OLEDs.

The converting circuit 192 converts the input data Data received from the timing controller 150 into the corrected data Data′ so that an image with substantially uniform brightness may be displayed regardless of the deterioration of the OLED and the threshold voltage and mobility of the driving transistor M2 using the first digital value and the second digital value that are stored in the memory 191.

The data driver 120 generates the data signal using the corrected data Data′ and supplies the generated data signal to the pixel 140.

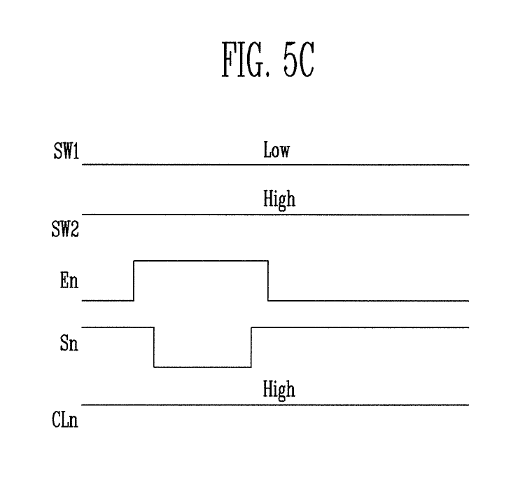

FIG. 5A is a waveform diagram illustrating the driving waveforms supplied in the first sensing period. In FIG. 5A, for the sake of convenience, the driving waveforms supplied to the nth scan line Sn and the nth sensing line CLn are illustrated.

Referring to FIG. 5A, the first switch SW1 is turned off and the second switch SW2 is turned on in the first sensing period. Then, a logic high voltage (e.g., logic high signal) is supplied to the emission control line En and the scan line Sn. That is, the emission control signal is supplied to the emission control line En and the scan signal is not supplied to the scan line Sn in the first sensing period.

The sensing signal is supplied to the sensing line CLn in the first sensing period. When the sensing signal is supplied to the sensing line CLn, the fourth transistor M4 is turned on. When the fourth transistor M4 is turned on, the data line Dm is coupled to the anode electrode of the OLED. In this case, in the first sensing period, the first current from the sensing circuit 181 is supplied to (e.g., flows to) the second power source ELVSS via the OLED. At this time, the first voltage appears across the OLED and the first voltage is converted into a first digital value by the ADC 182 and is stored in the memory 191. In the first sensing period, the sensing signals are sequentially supplied to the sensing lines CL1 to CLn and first digital values corresponding to the pixels 140 are stored in the memory 191.

FIG. 5B is a waveform diagram illustrating the driving waveforms supplied in the second sensing period. In FIG. 5B, for the sake of convenience, the driving waveforms supplied to the nth scan line Sn and the nth sensing line CLn are illustrated.

Referring to FIG. 5B, the first switch SW1 is turned off and the second switch SW2 is turned on in the second sensing period. A low voltage is supplied to the emission control line En. That is, the emission control signal is not supplied to the emission control line En in the second sensing period. In addition, the voltage of the second power source ELVSS is set so that the OLED is turned off in the second sensing period. For example, in the second sensing period, the second power supplied by the second power source ELVSS may have the same voltage as the first power supplied by the first power source ELVDD.

In the second sensing period, the scan signal is supplied to the scan line Sn and the sensing signal is supplied to the sensing line CLn so that the sensing signal is synchronized with the scan signal supplied to the scan line Sn. When the scan signal is supplied to the scan line Sn, the first transistor M1 is turned on. When the sensing signal is supplied to the sensing line CLn, the fourth transistor M4 is turned on. When the first transistor M1 is turned on, the data line Dm is electrically coupled to the first node N1. When the fourth transistor M4 is turned on, the data line Dm is electrically coupled to the anode electrode of the OLED and the second electrode of transistor M2. Therefore, transistor M2 is diode connected when the first transistor M1 and the fourth transistor M4 are turned on.

The sensing circuit 181 sinks the second current in the second sensing period. The second current is sunk by the sensing circuit 181 from the first power source ELVDD, via the third transistor M3, the second transistor M2, the fourth transistor M4, the data line Dm, and the second switch SW2. The second current sunk by the sensing circuit 181 passes through the second transistor M2 so that the second voltage corresponding to the second current appears at the first node N1. The second voltage is converted into a second digital value by the ADC 182 and is stored in the memory 191. In the second sensing period, the scan signals and the sensing signals are sequentially supplied to the scan lines S1 to Sn and the sensing lines CL1 to CLn and second digital values corresponding to the pixels 140 are stored in the memory 191.

FIG. 5C is a waveform diagram illustrating the driving waveforms supplied in the driving period. In FIG. 5C, for the sake of convenience, the driving waveforms supplied to the nth scan line Sn and the nth sensing line CLn will be illustrated.

Referring to FIG. 5C, in the driving period, the first switch SW1 is turned on and the second switch SW2 is turned off. Then, in the driving period, the emission control signals are sequentially supplied to the emission control lines E1 to En and the scan signals are sequentially supplied to the scan lines 51 to Sn. Here, the scan signal supplied to the ith (i is a natural number, e.g., i=n) scan line Si is supplied to completely overlap the emission control signal supplied to the ith emission control line Ei. For example, the emission control signal may have a wider width than the scan signal. The data signals are supplied to the data lines D1 to Dm in synchronization with the scan signals sequentially supplied to the scan lines S1 to Sn in the driving period.

Operation processes are described in detail as follows. In the driving period, the converting circuit 192 receives specific data Data from the outside (e.g., an external source) and generates corrected data Data′ using the first digital value and the second digital value extracted from the pixel 140 to which the specific data Data is to be supplied. The corrected data Data′ is generated by changing the specific data Data (or the bit of the specific data Data) so that the deterioration of the OLEDs and the threshold voltages and mobilities of the driving transistors may be compensated for. The corrected data Data′ generated by the converting circuit 192 is supplied to the data driver 120. The data driver 120 generates the data signals using the corrected data Data′.

The emission control signal is supplied to the emission control line En and the scan signal is supplied to the scan line Sn in the driving period. When the emission control signal is supplied to the emission control line En, the third transistor M3 is turned off. When the scan signal is supplied to the scan line Sn, the first transistor M1 is turned on. When the first transistor M1 is turned on, the data signal is supplied from the data line Dm to the first node N1 via the first transistor M1.

When the data signal is supplied to the first node N1, the second transistor M2 is turned on. Since the data signal has a voltage by which the second transistor M2 may be completely turned on, the threshold voltage Voled of the OLED is supplied to the second node N2. That is, in a first period T1, the first node N1 is set at the voltage Vdata of the data signal and the second node N2 is set at the threshold voltage Voled of the OLED.

Then, the supply of the scan signal to the scan line Sn is stopped and the supply of the emission control signal to the emission control line En is stopped. When the supply of the scan signal to the scan line Sn is stopped, the first transistor M1 is turned off. In this case, the first node N1 is floating. When the supply of the emission control signal to the emission control line En is stopped, the third transistor M3 is turned on.

When the third transistor M3 is turned on, the voltage of the second node N2 increases from the threshold voltage Voled of the OLED to the voltage of the first power source ELVDD. At this time, the voltage of the first node N1 increases to correspond to the amount of the increase in the voltage of the second node N2. That is, the second node N2 is set at the voltage of the first power source ELVDD and the first node N1 is set at the voltage of EQUATION 2.

V_{N1}=ELVDD−Voled+Vdata Equation 2

When the voltage of the first node N1 is set as illustrated in EQUATION 2, the voltage between the source of the second transistor M2 and the gate of the second transistor M2 is set as the voltage of EQUATION 3.

Vsg(M2)=Voled−Vdata Equation 3

When the voltage between the source electrode of the second transistor M2 and the gate electrode of the second transistor M2 is set as illustrated in EQUATION 3, the current that flows to the OLED is controlled (or determined) regardless of the first power source ELVDD. According to an embodiment of the present invention, an image with desired brightness may be displayed regardless of the voltage change (e.g., voltage drop) of the first power source ELVDD. In addition, since the data signal supplied to the pixel 140 is generated by the corrected data Data′, an image with desired brightness may be displayed regardless of the deterioration of the OLED and the threshold voltage and mobility of the second driving transistor M2.

While aspects of the present invention have been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

1. An organic light emitting display, comprising:
pixels positioned at crossing regions of scan lines, emission control lines, sensing lines, and data lines, wherein each of the pixels comprises:
an organic light emitting diode (OLED) having a cathode electrode coupled to a second power source;
a second transistor having a second electrode coupled to an anode electrode of the OLED in order to supply a current to the OLED;
a first transistor coupled between a data line of the data lines and a gate electrode of the second transistor and configured to be turned on when a scan signal is supplied to a scan line of the scan lines;
a third transistor coupled between a first electrode of the second transistor and a first power source and configured to be turned off when an emission control signal is supplied to an emission control line of the emission control lines; and
a storage capacitor coupled between the gate electrode of the second transistor and the first electrode of the second transistor;
a sensor for extracting information on deterioration of OLEDs and information on threshold voltages and mobilities of the second transistors of the pixels;
a converter for changing supplied data to generate corrected data using the information on the deterioration of the OLEDs and the information on the threshold voltages and mobilities of the second transistors; and
a data driver for generating data signals to be supplied to the data lines using the corrected data.

2. The organic light emitting display as claimed in claim 1, wherein a voltage of the data signals is less than or equal to a threshold voltage of the OLED.

3. The organic light emitting display as claimed in claim 1, wherein a voltage of a first power supplied by the first power source is higher than a threshold voltage of the OLED.

4. The organic light emitting display as claimed in claim 1, wherein a data signal of the data signals is set to completely turn on the second transistor.

5. The organic light emitting display as claimed in claim 1, wherein the corrected data compensates for the deterioration of the OLEDs and the threshold voltages and mobilities of the second transistors.

6. The organic light emitting display as claimed in claim 1, further comprising a switching unit coupled to the data lines for selectively coupling the data lines to one of the sensor or the data driver.

7. The organic light emitting display as claimed in claim 6, wherein the switching unit comprises:
a first switch coupled between the data lines and the data driver and configured to be turned on in a driving period where the data signals are supplied; and
a second switch coupled between the data lines and the sensor and configured to be turned on in a first sensing period where the information on the deterioration of the OLEDs is extracted and in a second sensing period where the information on the threshold voltages and mobilities of the second transistors is extracted.

8. The organic light emitting display as claimed in claim 7, wherein the sensor comprises:
a sensing circuit including a current source unit for supplying a first current to the OLED in the first sensing period and a current sink unit for sinking a second current via the second transistors of the pixels in the second sensing period; and
an analog-to-digital converter (ADC) for converting voltages corresponding to the first current and the second current into digital values.

9. The organic light emitting display as claimed in claim 1, wherein the converter comprises:
a memory for storing the deterioration information converted into a digital value by the sensor and the information on the threshold voltages and mobilities of the second transistors; and
a converting circuit for generating the corrected data using the information stored in the memory.

10. An organic light emitting display, comprising:
pixels positioned at crossing regions of scan lines, emission control lines, sensing lines, and data lines, wherein each of the pixels comprises:
an organic light emitting diode (OLED) having a cathode electrode coupled to a second power source;
a second transistor having a first electrode coupled to a first power source and a second electrode coupled to an anode electrode of the OLED in order to supply a current to the OLED;
a first transistor coupled between a data line of the data lines and a gate electrode of the second transistor and configured to be turned on when a scan signal is supplied to a scan line of the scan lines; and
a fourth transistor coupled between the second electrode of the second transistor and the data line and configured to be turned on when a sensing signal is supplied to a sensing line of the sensing lines;
a sensor for extracting information on deterioration of the OLEDs and information on threshold voltages and mobilities of the second transistors of the pixels;
a converter for changing supplied data to generate corrected data using the information on the deterioration of the OLEDs and the information on the threshold voltages and mobilities of the second transistors; and
a data driver for generating data signals to be supplied to the data lines using the corrected data.

11. The organic light emitting display of claim 10, wherein the sensor is configured to extract information on the deterioration of the OLED of a pixel of the pixels as a voltage appearing at the anode electrode of the OLED, the voltage corresponding to a current flowing from the sensor through the data line, the fourth transistor, and the OLED.

12. The organic light emitting display of claim 10, wherein the sensor is configured to extract information on a second transistor of a pixel of the pixels as a voltage appearing at the gate electrode of the second transistor, the voltage corresponding to a current flowing from the first power source through the second transistor, the fourth transistor, and the data line to the sensor.
